(19) United States
(12) Patent Application Publication
(10) Pub. No.: US 2018/0349358 A1
(43) Pub. Date: Dec. 6, 2018

(54) NON-TRANSITORY COMPUTER-READABLE STORAGE MEDIUM, INFORMATION PROCESSING DEVICE, AND INFORMATION GENERATION METHOD

(71) Applicant: FUJITSU LIMITED, Kawasaki-shi (JP)

(72) Inventors: Mikio Tahara, Hino (JP); Yoshio Akasofu, Kawasaki (JP)

(73) Assignee: FUJITSU LIMITED, Kawasaki-shi (JP)

(21) Appl. No.: 15/995,608

(22) Filed: Jun. 1, 2018

(30) Foreign Application Priority Data
Jun. 6, 2017 (JP) 2017-111802

(51) Int. Cl. G06F 17/28; G06F 17/30; G06K 9/00; G06F 17/27

(52) U.S. Cl. CPC G06F 17/28; G06F 17/30702; G06F 17/27; G06K 9/00456; G06F 17/30011

(57) ABSTRACT

A non-transitory computer-readable storage medium storing a program that causes a computer to execute a process, the process including acquiring information identifying a person, obtaining document data created by the person identified by the acquired information from a storage device based on the acquired information, the storage device storing pieces of document data, extracting one or a plurality of words from the obtained document data in accordance with an extraction rule determined based on a type of the obtained document data, generating person management information including the one or a plurality of words and the acquired information identifying the person, and storing the person management information to the storage device.

### CROSS-REFERENCE TO RELATED APPLICATION

This application is based upon and claims the benefit of priority of the prior Japanese Patent Application No. 2017-111802, filed on Jun. 6, 2017, the entire contents of which are incorporated herein by reference.

### FIELD

The embodiments discussed herein are related to a non-transitory computer-readable storage medium, an information processing device, and an information generation method.

### BACKGROUND

In recent years, reductions in time periods for development are requested in fields such as software development. It is, therefore, difficult to develop human resources during business operations and secure human resources, human resources with skills related to development are collected, and teams are created.

In the selection of human resources in order to create teams, human resources are evaluated based on self-assessments regarding specialized techniques, evaluation by close persons (for example, bosses or the like), test results, and whether or not each of the human resources has a license, and human resources that satisfy requirements are searched, for example.

Examples of related art are Japanese Laid-open Patent Publication No. 2013-191077 and Japanese Laid-open Patent Publication No. 2008-217321.

### SUMMARY

According to an aspect of the disclosure, a non-transitory computer-readable storage medium storing a program that causes a computer to execute a process, the process including acquiring information identifying a person, obtaining document data created by the person identified by the acquired information from a storage device based on the acquired information, the storage device storing pieces of document data, extracting one or a plurality of words from the obtained document data in accordance with an extraction rule determined based on a type of the obtained document data, generating person management information including the one or a plurality of words and the acquired information identifying the person, and storing the person management information to the storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram exemplifying a configuration of an information processing device according to an embodiment;

FIG. 2 is a diagram exemplifying a technical term dictionary according to the embodiment;

FIG. 3 is a diagram exemplifying an operational flow of a process of generating the technical term dictionary according to the embodiment;

FIG. 4 is a diagram exemplifying a content information item according to the embodiment;

FIG. 5 is a diagram exemplifying a person information item according to the embodiment;

FIGS. 6A to 6C are diagrams describing the flow of a process of extracting representative words according to the embodiment;

FIG. 7 is a diagram exemplifying extraction rule information according to the embodiment;

FIG. 8 is a diagram exemplifying the generation of a person management information item according to the embodiment;

FIG. 9 is a diagram exemplifying an operational flow of a process of generating the person management information item according to the embodiment;

FIG. 10 is a diagram exemplifying a human resource search process according to the embodiment;

FIG. 11 is a diagram exemplifying search results according to the embodiment;

FIG. 12 is a diagram exemplifying an operational flow of the human resource search process according to the embodiment;

FIG. 13 is a diagram exemplifying the generation of a person management information item according to another embodiment; and

FIG. 14 is a diagram exemplifying a hardware configuration of a computer that achieves the information processing device according to the embodiment.

### DESCRIPTION OF EMBODIMENTS

In the evaluation of human resources, it is considered that information on skills of the human resources is acquired from technical documents created through processes involving the human resources and to evaluate the human resources. The technical documents, however, are of various types, for example, patent documents, papers, specifications, and question and answer (Q & A) statements for handling customers, and technical skills requested to create the technical documents are different for the technical documents. Thus, for example, if the various types of technical documents are equally handled and the information on the skills is acquired, information appropriate to evaluate the human resources may not be obtained.

According to an aspect, an object is to generate information useful to evaluate human resources from various types of technical documents.

Hereinafter, embodiments are described in detail with reference to the accompanying drawings. Elements that correspond to each other in multiple drawings are indicated by the same reference symbol.

As described above, for example, in technical fields that are software development and the like and in which reductions in time periods for development are requested, human resources with skills related to the development are collected and teams are created. In the selection of human resources in order to create teams, human resources are evaluated based on self-assessments regarding specialized techniques, evaluation by close persons (for example, bosses or the like), test results, and whether or not each of the human resources have a license, and human resources that satisfy requirements are searched, for example.

In the evaluation of human resources, it is considered that information on skills of the human resources is acquired from technical documents created through processes involving the human resources and to evaluate the human resources, for example. The technical documents, however, are of various types, for example, patent documents, papers, specifications, and question and answer (Q & A) statements for handling customers, and technical skills requested to create the technical documents are different for the technical documents. Thus, for example, if the various types of technical documents are equally handled and the information on the skills is acquired, information appropriate to evaluate the human resources may not be obtained. It is, therefore, desirable to provide a technique for generating information useful to evaluate human resources from various types of technical documents.

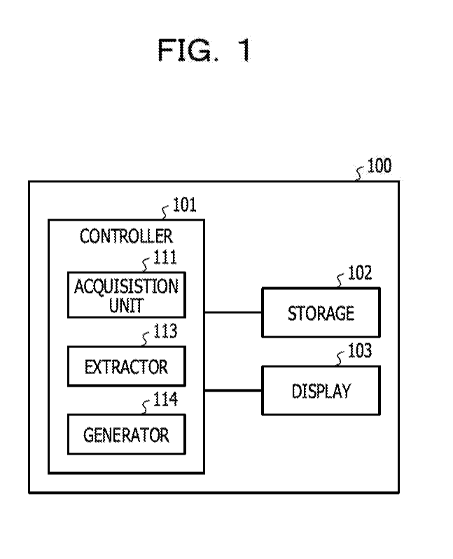

In an embodiment described below, words that characterize technical documents are extracted from the various types of technical documents created by a certain human resource and are used as information indicating skills of the human resource. In addition, upon the extraction of the words characterizing the documents, an extraction rule is changed based on each of types of the documents. For example, the number of words to be extracted from a paper for which a high technical level is requested to create the paper is large. On the other hand, the number of words to be extracted from an instruction document for which a lower technical skill than that requested to create a paper is considered to be requested is smaller than the number of words to be extracted from the paper. For example, extraction rules may be determined based on the types of technical documents, and words are extracted from the technical documents in accordance with the extraction rules. By changing an extraction rule based on a technical level requested to create a technical document, it is possible to weight words based on the technical level requested for the technical document, extract words, and use the extracted words to evaluate a human resource. Furthermore, it is possible to extract information on human resources from a wide range of technical documents and extract highly accurate information on human resources. Hereinafter, the embodiment is described in more detail. FIG. 1 is a block diagram exemplifying a configuration of an information processing device 100 according to the embodiment. For example, the information processing device 100 may execute a process of generating person management information items 800 (described later) according to the embodiment. The information processing device 100 may be a computer such as a personal computer (PC) or a laptop computer, for example. The information processing device 100 includes a controller 101, a storage 102, and a display 103, for example. The controller 101 may operate as an acquisition unit 111, an extractor 113, a generator 114, and the like, for example. The storage 102 of the information processing device 100 may store information such as a technical term dictionary 200 described later, content information items 400 and 600, person information items 500, extraction rule information 700, the person management information items 800, and association information 1000, for example. The display 103 displays information, for example. Details of these sections and details of the information stored in the storage 102 are described later.

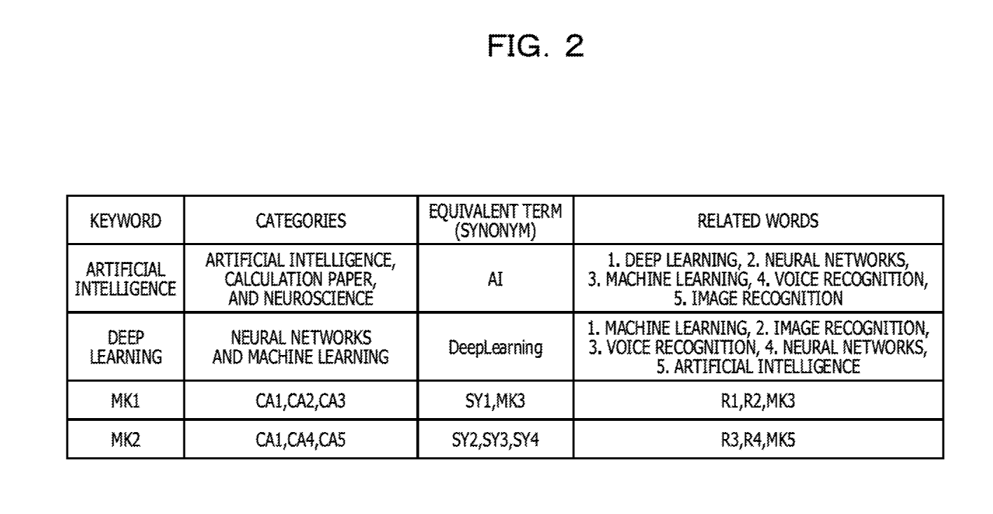

FIG. 2 is a diagram exemplifying the technical term dictionary 200 according to the embodiment. In the technical term dictionary 200, entries that include information on technical terms are registered, for example. The entries of the technical term dictionary 200 include information of a keyword (word) column, a categories column, an equivalent term (synonym) column, and a related words column. In the keyword column, the technical terms associated with the entries are registered, for example. In the categories column, terms indicating technical fields to which the keywords associated with the entries belong are registered, for example. In the equivalent term (synonym) column, synonyms of the keywords associated with the entries are registered, for example. In the related words column, technical terms related to the keywords associated with the entries are registered, for example.

For example, in an entry in which a keyword is artificial intelligence, categories to which artificial intelligence belongs include artificial intelligence, calculation papers, and neuroscience. In this entry, AI that is an abbreviation of artificial intelligence is registered as a synonym of the keyword that is artificial intelligence. In this entry, deep learning, neural networks, machine learning, voice recognition, and image recognition are included as related words of the keyword that is artificial intelligence. In the embodiment, ranks may be assigned to the related words in order from a word having the highest relevance to the keyword. For example, in FIG. 2, the top rank is assigned to deep learning, the second rank is assigned to neural networks, and the third rank is assigned to machine learning. In another embodiment, ranks may not be assigned to the related words. Details of the ranking of the related words are described later.

The controller 101 may collect information from existing dictionary data or the like and register entries in the technical term dictionary 200, for example. Alternatively, the controller 101 may collect information from a dictionary site describing explanations of technical terms on the Internet or the like and register entries in the technical term dictionary 200.

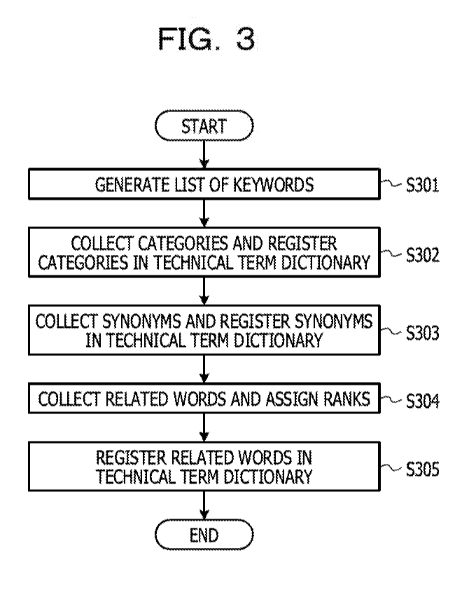

FIG. 3 is a diagram exemplifying an operational flow of a process, to be executed by the controller 101 of the information processing device 100 according to the embodiment, of generating the technical term dictionary 200. When an instruction to execute the process of generating the technical term dictionary 200 is input to the information processing device 100, the controller 101 may start the operational flow illustrated in FIG. 3. In another embodiment, a user may operate the information processing device 100 and register entries in the technical term dictionary 200.

In step 301 (hereinafter, step is described as “S” and, for example, step 301 is expressed as S301), the controller 101 of the information processing device 100 collects technical terms and generates a list of keywords, for example. For example, the controller 101 crawls a dictionary site describing explanations related to technical terms on the Internet or the like and collect the technical terms from the dictionary site. Then, the controller 101 may use the collected technical terms as keywords to be processed, generate entries associated with the keywords to be processed, and register the entries in the technical term dictionary 200.

In S302, the controller 101 identifies categories to which the keywords to be processed belong. For example, information of the categories may be already added to the technical terms, depending on the dictionary site describing the technical terms or the like. In this case, the controller 101 may crawl the dictionary site and collect the information of the categories added to the technical terms. Then, the controller 101 registers the collected information of the categories in the categories column within the entries associated with the keywords to be processed.

In S303, the controller 101 collects synonyms of the keywords to be processed. For example, the controller 101 may crawl a website providing a thesaurus (dictionary of synonyms) or the like, collect the synonyms of the keywords to be processed, and register the collected synonyms in the synonym column within the entries included in the technical term dictionary 200 and associated with the keywords to be processed.

In S304, the controller 101 collects related words that are related to the keywords to be processed and assigns ranks to the related words based on relevance between the keywords to be processed and the related words. For example, the controller 101 may crawl a website including the keywords to be processed and collect, as the related words, words appearing together with the keywords to be processed in the website. Then, the controller 101 may acquire frequencies at which the related words appear together with the keywords to be processed in the website, or the controller 101 may acquire the numbers of times that the related words appear together with the keywords to be processed in the website, and the controller 101 may assign ranks to the related words so that as the frequency at which a related word appears is higher or the number of times that the related word appears is larger, a higher rank is assigned to the related word.

In S305, the controller 101 registers the related words and information of the ranks in the entries included in the technical term dictionary 200 and associated with the keywords to be processed. After S305, the controller 101 terminates the operational flow.

In the embodiment, the controller 101 may register the entries in the technical term dictionary 200 in the aforementioned manner. For example, by crawling the Internet or the like to which new information is frequently added, collecting information, and generating entries, it is possible to register entries of keywords related to the latest skill in the technical term dictionary 200. In another embodiment, the controller 101 may generate entries of the technical term dictionary 200 from dictionary data stored in the local storage 102 or promote a user to enter information of entries of the technical term dictionary 200, and the user may enter the information of the entries.

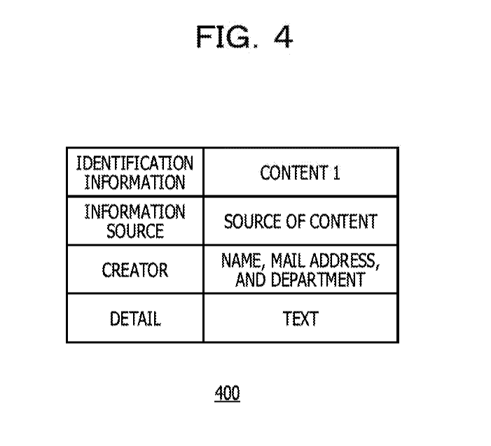

Subsequently, the generation of the person management information items 800 including information on techniques and skills of human resources is described with reference to FIGS. 4 to 8.

FIG. 4 is a diagram exemplifying a content information item 400 according to the embodiment. A content information item 400 may be generated for each technical document, for example. Document data such as technical documents is hereinafter referred to as contents. The contents may include a paper, a patent document, a book, a specification, an instruction document, an article of a Q & A site, an article of a blog related to a technology, a design document, a presentation document, a report, and the like, for example. The content information item 400 may include information on a content or may include identification information, an information source, a creator, and a detail.

The identification information indicates the content associated with the content information item 400. The information source indicates an information source from which the content associated with the content information 400 has been collected. For example, in a company or the like, contents created by employees are classified into types and managed using databases. Storage locations may be determined based on the types, for example, papers created by employees are registered in a database for managing papers, specifications are registered in a database for managing specifications, and patent documents are registered in a database for managing patent documents. In this case, information of a database from which data is collected and information of a storage location at which the collected data is stored may be registered in the information source. In another example, if data of the content is collected from a predetermined site on the Internet, information of a uniform resource locator (URL) of the predetermined site may be registered in the information source.

The creator indicated in the content information item 400 is information indicating a creator of the content associated with the content information item 400. For example, the creator indicated in the content information item 400 may include information of the name of the creator, a mail address of the creator, and a department of the creator. The department may be information indicating a department to which the creator belongs in a company, an organization, or the like. As an example, the information registered in the creator may be collected from the content associated with the content information item 400. In another example, the information registered in the creator may be registered by a user.

The detail may be information of a text such as a statement described in the content associated with the content information item 400.

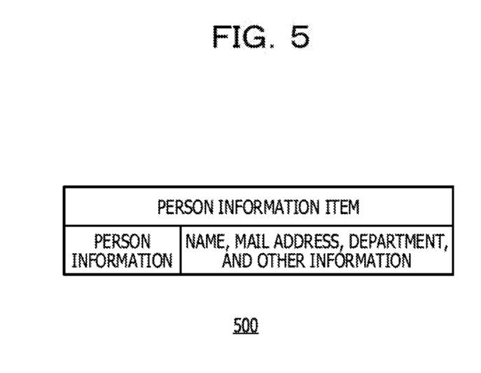

FIG. 5 is a diagram exemplifying a person information item 500. A person information item 500 may be generated for each of persons whose information on skills is to be collected. The person information items 500 may include information on the persons. In an example, each of the person information items 500 may include information of the name of a person associated with the person information item 500, a mail address of the person, a department of the person, and other information. The other information may include information indicating past business experience of the person, a past department of the person, and the like.

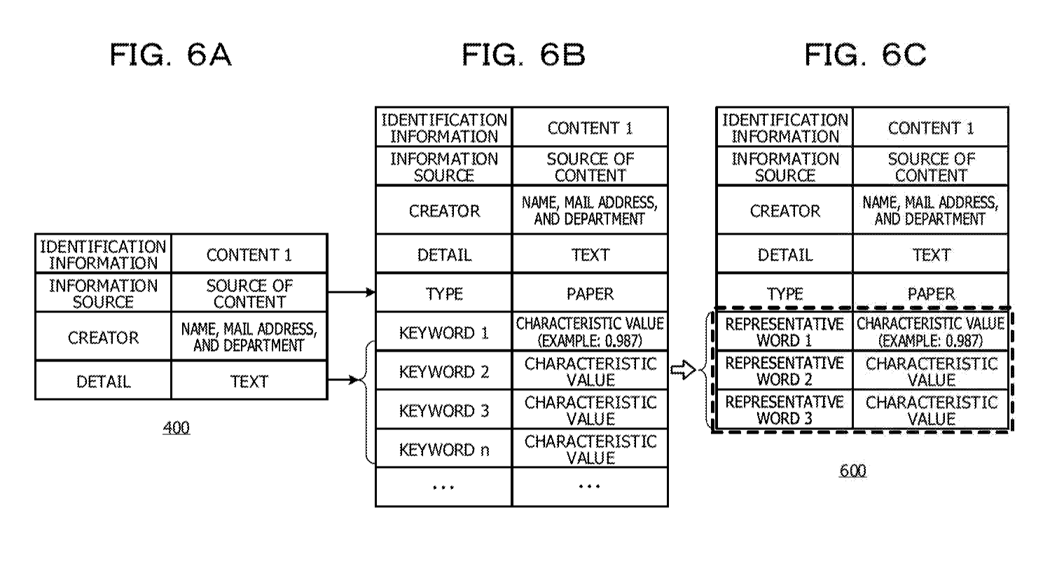

Subsequently, a process of identifying a word representing a content from multiple words included in text data within the content is described. FIGS. 6A to 6C are diagrams describing the flow of a process of extracting representative words.

First, the controller 101 identifies keywords that are included in text data indicated in a detail included in a content information item 400 illustrated in FIG. 6A and are among keywords registered in the technical term dictionary 200, for example. Then, the controller 101 calculates, for the identified keywords, characteristic values that are indices indicating characteristic degrees of the keywords within the content (FIG. 6B). The characteristic values may be TF-IDF values as an example.

The TF-IDF values are indices that are used in fields such as information seeking and text mining and identify the characteristic degrees of the identified words appearing in a document. TF of the TF-IDF values is an abbreviation of term frequency and indicates the numbers of times that the identified words appear in the document. Each of the TFs is, for example, an index based on the idea that as the frequency at which a word appears in a document is higher, the word is more important. IDF of the TF-IDF values is an abbreviation of inverse document frequency and may be natural logarithms of document frequencies (DFs). Each of the DFs is, for example, the number of documents that are among multiple documents to be used to calculate a characteristic value of a word and include the word. Each of the DFs is an index based on the idea that a word that is used in multiple documents in a cross-sectoral manner is not important. In addition, for example, values obtained by multiplying the TFs by the IDFs are the TF-IDF values of the words included in the document. In the embodiment, the controller 101 may determine that as a TF-IDF value of a word among multiple words included in the content is higher, the word is more important.

The TF-IDF values are based on frequencies at which the words appear in the content. If a specific keyword appears in a short content multiple times, the TF-IDF value of the word may be abnormally high. Thus, the controller 101 may exclude the keyword having the abnormal TF-IDF value from representative words (described later) to be extracted. For example, it is assumed that a TF-IDF value is not calculated from a content including a statement including 10 keywords or more and 1000 characters or more or is not in a predetermined range (for example, 0.01≤TF-IDF≤1.00). In this case, the controller 101 may exclude a keyword having the TF-IDF value in the extraction (described later) of representative words.

In another embodiment, values obtained by correcting the TF-IDF values may be used as the characteristic values. As an example, the controller 101 may correct the TF-IDF values based on a measure such as the importance or newness of a technology indicated by the words. Alternatively, the characteristic values may be other values from which the importance of the keywords that are included in the content information item 400 to be processed and are to be processed is able to be evaluated.

Subsequently, the controller 101 extracts, based on the characteristic values calculated for the keywords, representative words representing the content from the multiple keywords included in the content, for example. The controller 101 may change an extraction rule based on the type of the content associated with the content information item 400 upon the extraction of the representative words.

First, the controller 101 identifies the type of the content based on information indicated in the information source of the content information item 400, for example. For example, if information of a database for managing papers is registered in the information source, the controller 101 may determine, as a paper, the type of the content associated with the content information item 400. Similarly, for example, if information of a database for managing specifications is registered in the information source, the controller 101 may determine, as a specification, the type of the content associated with the content information item 400. The controller 101 may identify the type of the content based on the information source in the aforementioned manner, but the embodiment is not limited to this. For example, the controller 101 may determine the type of the content based on a word included in the content and characterizing the type of the content. Alternatively, the controller 101 may promote the user to register information of the type, and the user may register the information of the type in the content information item 400, instead of the information source of the content information item 400.

Then, the controller 101 may acquire an extraction rule based on the type of the content after identifying the type of the content. As an example, the extraction rule may be a rule of extracting the number of representative words equal to an extraction number defined based on the type. For example, the storage 102 of the information processing device 100 may store extraction rule information 700 defining the numbers of representative words equal to extraction numbers defined based on document types.

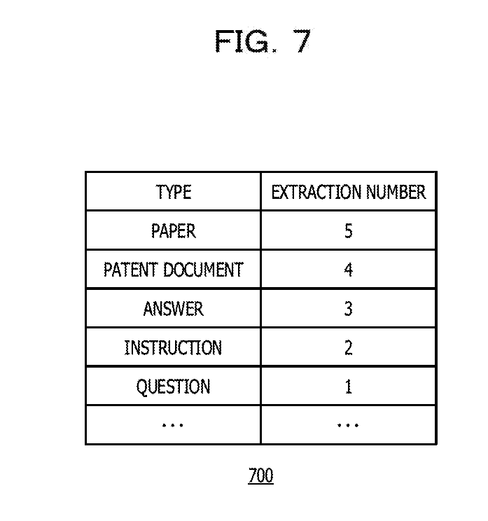

FIG. 7 is a diagram exemplifying the extraction rule information 700 according to the embodiment. The extraction rule information 700 includes information indicating the types and the extraction numbers. The types are information indicating the content types, for example. The extraction numbers indicate the numbers of representative words to be extracted, for example.

The controller 101 acquires, from the extraction rule information 700, an extraction number associated with the type identified for the content information item 400. The controller 101 extracts, as representative words, the number of keywords equal to the extraction number associated with the type from multiple words included in the content in order from a word associated with the highest characteristic value and generates a content information item 600 illustrated in FIG. 6C.

The content information item 600 illustrated in FIG. 6C is obtained by adding information indicating the representative words and characteristic values of the representative words to the content information item 400.

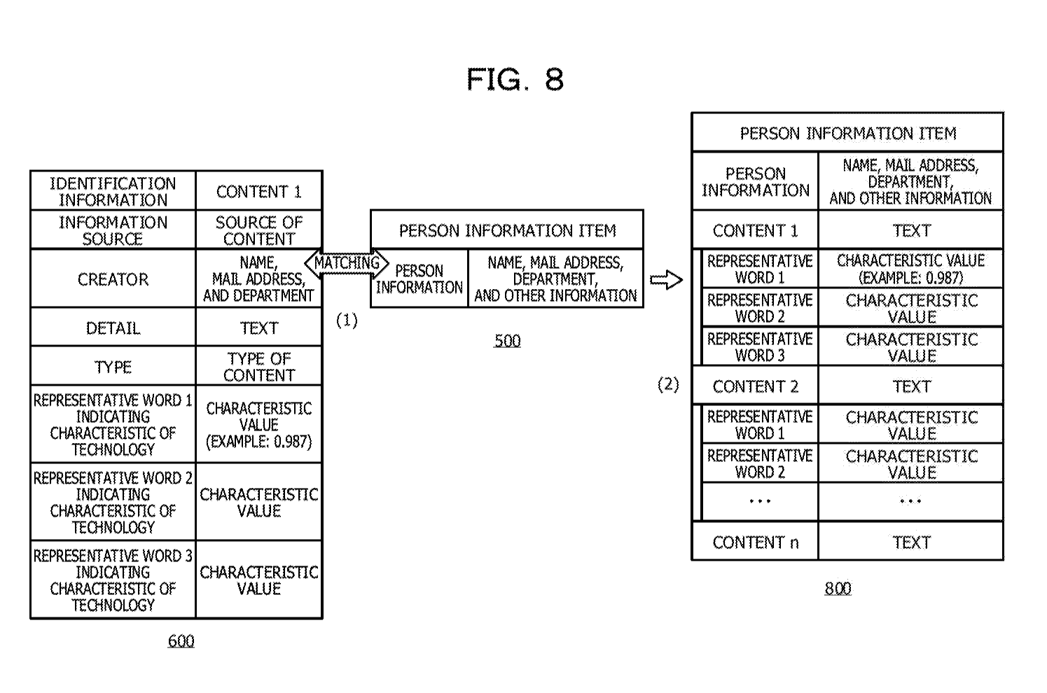

Subsequently, the controller 101 combines the content information item 600 with the person information item 500 to generate a person management information item 800. FIG. 8 is a diagram exemplifying the generation of the person management information item 800.

For example, the controller 101 executes the matching of the content information item 600 with the person information item 500 ((1) illustrated in FIG. 8). For example, the controller 101 collects the content information item 600 including information matching the person information item 500 in the creator of the content information item 600. Then, the controller 101 adds the identification information of the collected content information item 600, the detail of the collected content information item 600, the representative words of the collected content information item 600, the characteristic values of the representative words of the collected content information item 600 to the person information item 500 to generate the person management information item 800 ((2) illustrated in FIG. 8).

As exemplified in FIG. 8, the person management information item 800 includes information registered in the person information item 500, the identification information included in the content information item 600 associated with the person information item 500, the detail of the content, the representative words, and the characteristic values of the representative words. If multiple content information items 600 match the person information item 500, the controller 101 may register information of the matched content information items 600 in the person management information item 800.

For example, in the aforementioned manner, the controller 101 may generate the person management information item 800 and cause the generated person management information item 800 to be stored in the storage 102. In the person management information item 800, technical terms estimated to be words important to contents created through processes involving a human resource associated with the person management information item 800 are registered. Thus, the user may use the person management information item 800 to search the human resource having a skill in a desired field. In addition, the number of representative words registered in the person management information item 800 varies depending on the content type. In the aforementioned embodiment, as a technical level requested for the creation of a content is higher, the controller 101 extracts a larger number of representative words from the content. Thus, the controller 101 may suppress the extraction of a large number of representative words from a document of a low technical level and the extraction of a word that has low relevance to a skill of a human resource and serves as noise in the search of a human resource. In addition, by extracting a large number of representative words from a document of a high technical level, it is possible to acquire detailed information on a skill of a human resource.

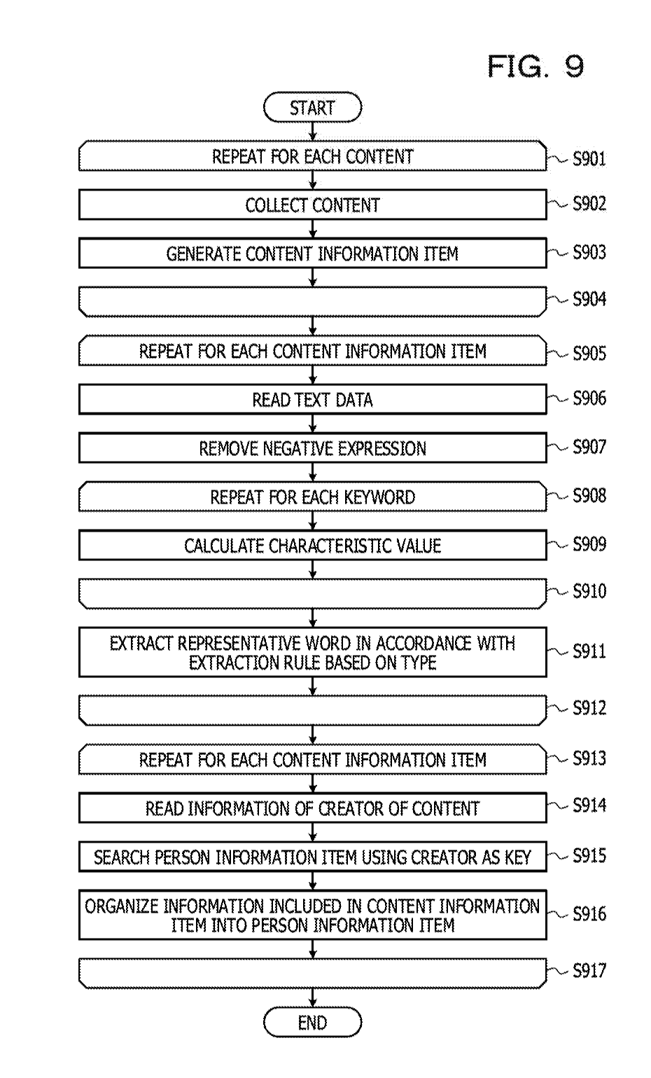

FIG. 9 is a diagram exemplifying an operational flow of a process of generating the person management information item 800 described with reference to FIGS. 6A to 8. When an instruction to execute the process of generating the person management information item 800 is input to the information processing device 100, the controller 101 may start the operational flow illustrated in FIG. 9.

Processes of S901 to S904 are repetitive processes to be executed on each content to be collected. In S902, the controller 101 collects a single content. For example, the controller 101 accesses an information source such as a database or the like from which the content is to be collected, and the controller 101 reads the single content from the information source.

In S903, the controller 101 generates a content information item 400 from the collected content. For example, the controller 101 may assign an identifier to the collected content in order to distinguish between the collected content and other contents and may register the assigned identifier in identification information of the content information item 400 associated with the collected content. In addition, the controller 101 may acquire information of the database serving as the information source from which the content has been collected and the like, and the controller 101 may register the acquired information in an information source indicated in the content information item 400. The controller 101 may collect information on a creator of the collected content and register the collected information on the creator in a creator indicated in the content information item 400. The controller 101 may acquire the information on the creator of the content from text data within the collected content or the like or from information registered in the database serving as the information source of the content, for example. The controller 101 may register the text data included in the collected content in a detail indicated in the content information item 400.

Then, the controller 101 generates content information items 400 corresponding to all collected contents by repeatedly executing the processes of S901 to S904. The collected contents may be all contents registered in the database specified as the information source from which the contents have been collected, for example. Alternatively, the collected contents may be contents satisfying a predetermined requirement. In addition, the information source of the contents may be multiple databases, for example.

Processes of S905 to S912 are repetitive processes to be executed on each of the content information items 400 generated from the collected contents and serving as content information items 400 to be processed. In S906, the controller 101 reads text data from a detail indicated in a content information item 400 to be processed.

In S907, the controller 101 removes a negative expression from a statement included in the read text data. For example, the controller 101 may execute natural language analysis on the read text data and extract a sentence, a clause, and a phase that include a negative word. The negative expression is, for example, an entire sentence “I am not good at English.”. Alternatively, if there is a sentence “I am bad at speaking English and not able to speak English at all, but I am able to speak French.”, the negative expression is, for example, parts of the sentence, such as “bad at speaking English” and “not able to speak English at all”. Negative words included in the sentence are negative terms “bad”, “not good”, and “not able to speak”. The sentence, the clause, and the phase that include the negative word are removed, since it is preferable to extract positive information of skills for the evaluation of a skill of a human resource, for example. For example, if the aforementioned negative expression appears in a document a large number of times, the word “English” appears multiple times and the controller 101 may determine that “English” is an important term in the statement. However, if a human resource is searched, it is unlikely to search a human resource who is not good at “English”. Specifically, for example, even if the word “English” is used in a negative statement a large number of times, the word may not be information useful to evaluate a skill. Thus, in the embodiment, the controller 101 may remove a sentence, a clause, and a phase that include a negative word from the content information item 400 to be processed. For example, negative expressions may include expressions “This document excludes a technology for ***.” and “A part of *** is not so good in this report.”.

The processes of S908 to S910 are repetitive processes to be executed on each keyword registered in the technical term dictionary 200 and serving as a keyword to be processed. In S909, the controller 101 determines whether or not a keyword to be processed is included in the text data read from the content information item 400 to be processed. If the keyword to be processed is included in the text data read from the content information item 400 to be processed, the controller 101 calculates a characteristic value for the keyword to be processed. The characteristic value may be a TF-IDF value, for example. Alternatively, the characteristic value may be a value obtained by correcting the TF-IDF value based on the trend, newness, and importance of a technology indicated by the keyword or may be another value that enables the evaluation of the importance of the keyword that is to be processed and is included in the content information item 400 to be processed. It is assumed that the characteristic value is not calculated from a content including a statement including 10 keywords or more and 1000 characters or more or is not in a predetermined range (for example, 0.01≤TF-IDF≤1.00). In this case, the controller 101 may exclude a keyword having the TF-IDF value in the extraction of representative words in S911 described later.

By repeatedly executing the processes of S908 to S910, characteristic values are calculated for keywords included in the text data of the content information item 400 to be processed, for example.

In S911, the controller 101 extracts a representative word from the keywords included in the content information item 400 to be processed, based on the characteristic values in accordance with an extraction rule based on the type of the content. For example, the controller 101 may identify the type of the content associated with the content information item 400 based on the information source indicated in the content information item 400 to be processed. Alternatively, the controller 101 may identify the type of the content from the text data included in the detail indicated in the content information item 400, or the controller 101 may promote the user to register information indicating the type of the content in the content information item 400, and the user may register the information indicating the type of the content in the content information item 400, instead of the information source. Then, the controller 101 may identify an extraction number associated with the type of the content from the extraction rule information 700. For example, if the content information item 400 to be processed corresponds to a paper, the controller 101 may identify 5 representative words to be extracted. If the content information item 400 to be processed corresponds to an instruction document, the controller 101 may identify 2 representative words to be extracted. Then, the controller 101 extracts, as representative words, the number of keywords equal to the extraction number associated with the type of the content in order from a keyword associated with the largest characteristic value, registers the extracted representative words in the content information item 400 to be processed, and generates a content information item 600.

Writers who have different technical levels may write a document of a single content. For example, regarding a Q & A site, it is estimated that an answerer has a higher technical level than that of a questioner. In this case, it is not preferable to treat a question statement the same as an answer statement and extract words. In the embodiment, the controller 101 may treat, as different contents, statements included in a single content and estimated to be of different technical levels and extract representative words in accordance with extraction rules defined for the different contents. Specifically, for example, if a representative word is to be extracted from a Q & A site written by a certain writer, and the writer writes a question statement, the controller 101 may extract the number (1 associated with a question in the example illustrated in FIG. 7) of representative words equal to an extraction number associated with the type of the question statement and generate a content information item 600. If the writer writes an answer statement, the controller 101 may extract the number (3 associated with an answer in the example illustrated in FIG. 7) of representative words equal to an extraction number associated with the type of the answer statement and generate a content information item 600. Since it is expected that a technical level requested for an answer statement is higher than a technical level requested for a question statement, the extraction number associated with the answer is set to be larger than the extraction number associated with the question in the extraction rule information 700.

By executing the repetitive processes of S905 to S912, content information items 600 including representative words extracted based on types are generated for the content information items 400.

Processes of S913 to S917 are repetitive processes to be executed on each content information item 600 as a content information item 600 to be processed.

In S914, the controller 101 reads information of a creator indicated in a content information item 600 to be processed. In S915, the controller 101 identifies a person information item 500 including information matching the creator indicated in the content information item 600 to be processed.

In S916, the controller 101 organizes, into the identified person information item 500, information including identification information indicated in the content information item 600 to be processed, a detail indicated in the content information item 600 to be processed, representative words indicated in the content information item 600 to be processed, and characteristic values of the representative words, for example.

By repeatedly executing the processes of S913 to S917, the controller 101 may generate the person management information item 800. In the repetitive processes, if the information obtained from the content information item 600 and to be organized is already included in the person information item 500, the controller 101 does not search a new person information item 500 in S916 and searches the person information item 500 including the organized information. Then, in S916, the controller 101 may additionally register information obtained from the content information item 600 in the person information item 500 including the organized information. In S917, the person management information item 800 is generated by executing the processes on the content information items 600 as the content information items 600 to be processed. After S917, the operational flow is terminated.

As described above, according to the operational flow illustrated in FIG. 9, a person management information item 800 in which a human resource is associated with representative words extracted from contents created through processes involving the human resource is generated. In the person management information item 800, technical terms estimated as important words in the contents created through the processes involving the human resource associated with the person management information item 800 are registered. Thus, the user may use person management information items 800 to search human resources having desired knowledge.

The numbers of representative words registered in a person management information item 800 are different for contents. For example, in the aforementioned embodiment, as a technical level requested to create a content is higher, a larger number of representative words are extracted from the content. It is, therefore, possible to suppress the extraction of a large number of representative words from a document of a low technical level and the extraction of a word having low relevance to a human resource's skill and serving as noise in the search of a human resource. In addition, by extracting a large number of representative words from a document of a high technical level, it is possible to acquire detailed diverse information on a human resource's skill.

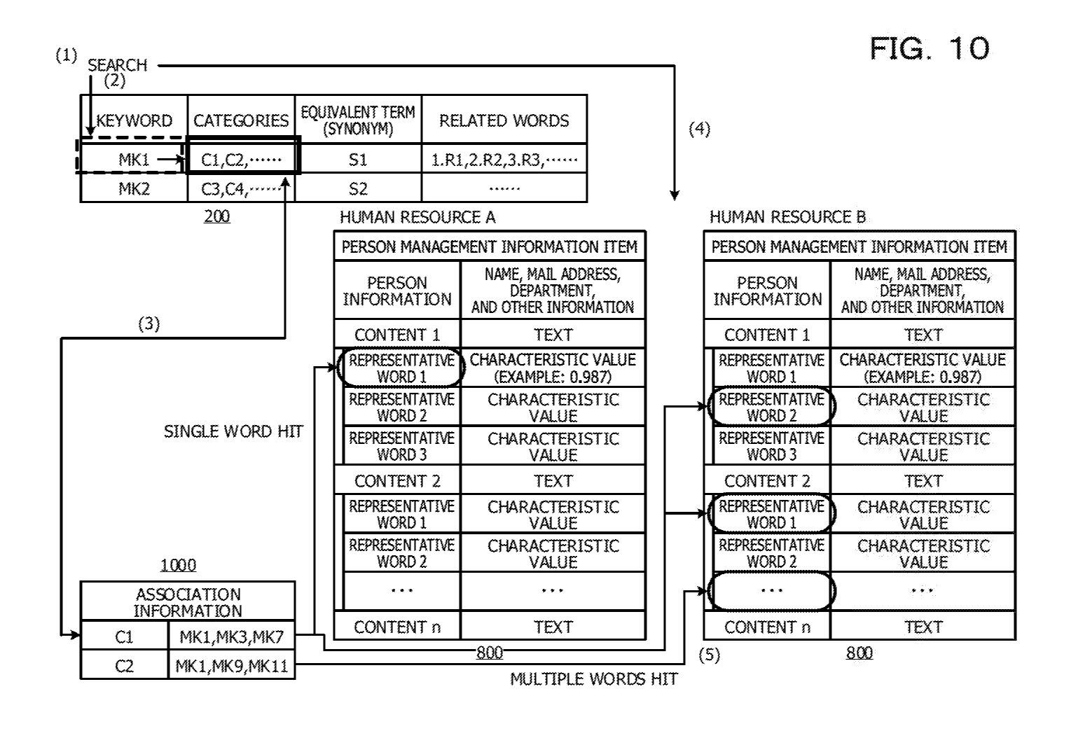

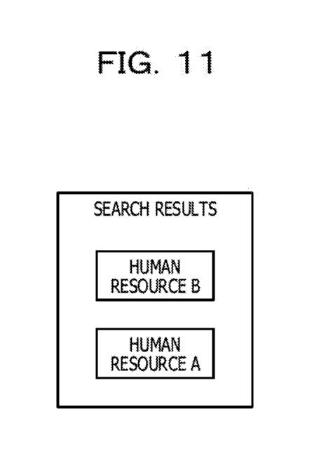

Subsequently, a human resource search to be executed using person management information items 800 is exemplified. For the human resource search, information such as a category, a synonym, and a related word of the technical term dictionary 200 may be used. An example of the human resource search is described with reference to FIGS. 10 and 11.

FIG. 10 is a diagram exemplifying a human resource search process according to the embodiment. For example, in the case where the user searches a human resource who is familiar with a certain technology, the user may enter a keyword related to the certain technology as a search key in the information processing device 100 ((1) illustrated in FIG. 10). When the search key is entered, the controller 101 of the information processing device 100 searches the keyword included in the technical term dictionary 200 based on the keyword entered as the search key and acquires information of categories (hereinafter referred to as related categories in some cases) to which the keyword belongs ((2) illustrated in FIG. 10). Subsequently, the controller 101 extracts, from the technical term dictionary 200, keywords belonging to the acquired related categories included in the categories column of the technical term dictionary 200 and generates association information 1000 ((3) illustrated in FIG. 10). As illustrated in FIG. 10, the keywords that belongs to the related categories are extracted from the technical term dictionary 200 into the association information 1000.

In addition, when the search key is entered, the controller 101 extracts person management information items 800 including the keyword entered as the search key as a representative word ((4) illustrated in FIG. 10). In FIG. 10, the person management information items 800 of human resources A and B are extracted and the human resources A and B have been involved in the creation of a content including the keyword entered as the search key as the representative word. In addition, the controller 101 searches the extracted person management information items 800 using the multiple keywords associated with the categories in the association information 1000 and counts the numbers of representative words hit in the search ((5) illustrated in FIG. 10). For example, it is expected that a human resource of a person management information item 800 in which the number of representative words hit in the search is larger, has a wider range of knowledge in a related technical field of the keyword entered as the search key than a human resource of a person management information item 800 in which the number of representative words hit in the search is smaller. Thus, the controller 101 may present, to the user, the human resource of the person management information item 800 in which the number of representative words hit in the search is larger, while prioritizing the human resource of the person management information item 800 in which the number of representative words hit in the search is larger.

FIG. 11 is a diagram exemplifying search results output by the controller 101. The human resources A and B are displayed so that the human resource B of the person management information item 800 in which the number of representative words hit in the search is larger, is prioritized over the human resource A of the person management information item 800 in which the number of representative words hit in the search is smaller. Since the human resource B who is likely to have a wider range of knowledge in the related technical field of the keyword entered as the search key than the human resource A is prioritized over the human resource A and displayed, the user may efficiently search a human resource having a desired skill.

The example illustrated in FIG. 10 describes the case where the keywords related to the keyword entered as the search key are acquired by generating the association information 1000 and using the categories, but the embodiment is not limited to this. For example, the controller 101 may acquire, from the technical term dictionary 200, a related word associated with the keyword entered as the search key, use the acquired related word for the search of a representative word, and count the number of hits.

The example indicated by (4) in FIG. 10 describes the case where the person management information items 800 that include the keyword entered as the search key as the representative word are extracted, but the embodiment is not limited to this. For example, in another embodiment, processes indicated by (5) and later in FIG. 10 may be executed on all person management information items 800 without the extraction of the person management information items 800 based on the keyword entered as the search key as indicated by (4) in FIG. 10. In this case, the extracted person management information items 800 may not include the keyword entered as the search key, but a human resource who is familiar with a technology related to the keyword entered as the search key may be prioritized over other human resources and presented while being ranked high.

The example illustrated in FIG. 10 describes the case where the order in which the search results are to be displayed is changed in accordance with the number of the hit keywords related to the keyword entered as the search key. The embodiment, however, is not limited to this. For example, in another embodiment, human resources may be presented to the user so that a human resource of a person management information item including a larger number of content information items of contents of types for which high technical levels are requested, is prioritized over a human resource of a person management information item including a smaller number of content information items of contents of types for which high technical levels are requested. Specifically, the controller 101 may display human resources so that a human resource of a person management information item 800 including a large number of content information items 600 associated with papers is prioritized over a human resource of a person management information item 800 including a large number of content information items 600 associated with instruction documents.

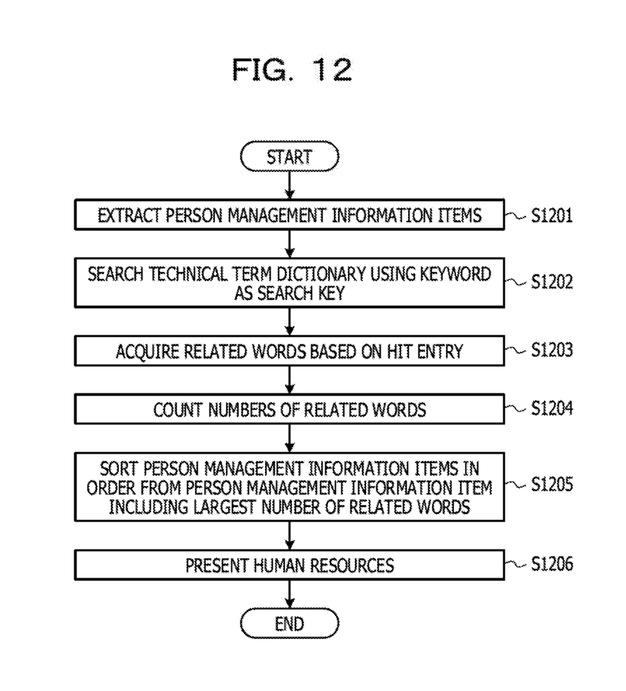

FIG. 12 is a diagram exemplifying an operational flow of the human resource search process according to the embodiment. For example, upon receiving a keyword entered as a search key, the controller 101 may start the operational flow illustrated in FIG. 12.

In S1201, the controller 101 extracts person management information items 800 including the keyword entered as the search key as a representative word. In S1202, the controller 101 searches the technical term dictionary 200 using the keyword entered as the search key and acquires an entry included in the technical term dictionary 200 and including the keyword in the keyword column.

In S1203, the controller 101 uses information of the entry hit in the search to acquire related words that are keywords related to the keyword entered as the search key. For example, the controller 101 may acquire the related words included in the hit entry. Alternatively, the controller 101 may acquire categories of the hit entry, extract keywords belonging to the acquired categories from the technical term dictionary 200, and use the extracted keywords as the related words.

In S1204, the controller 101 counts the numbers of related words included in representative words indicated in the extracted person management information items 800. Then, in S1205, the controller 101 sorts the extracted person management information items 800 so that as the number of related words that serve as representative words and are included in a person management information item 800 is larger, the person management information item 800 is more prioritized.

In S1206, the controller 101 may extract a predetermined number of person management information items 800 in order from a person management information item 800 having the largest number of related words and present human resources associated with the extracted person management information items 800 to the user. For example, the controller 101 may sort the person management information items 800 in order from a person management information item 800 having the largest number of related keywords and cause information of human resources associated with the person management information items 800 to be displayed on a display screen of the display 103 included in the information processing device 100, as illustrated in FIG. 11. The embodiment, however, is not limited to this. For example, in another embodiment, the controller 101 may present human resources to the user so that a human resource of a person management information item 800 including information of a larger number of contents of high technical levels, is prioritized over a human resource of a person management information item 800 including information of a smaller number of contents of high technical levels.

As described above, according to the operational flow illustrated in FIG. 12, information of human resources may be presented to the user based on contents created through processes involving the human resources.

The embodiment is described above but is not limited to this. For example, the aforementioned operational flows are examples, and the embodiment is not limited to this. In each of the operational flows, the order in which processes are executed may be changed, the processes may be executed in the changed order, and an additional process may be executed or a part of the processes may be omitted. For example, in the operational flow illustrated in FIG. 12, if the user does not create a technical document including a keyword entered as a search key and wants to search a human resource who is familiar with a technical field related to the keyword, the process of S1201 may not be executed. In this case, the controller 101 may execute the processes of S1202 and later on all the person management information items 800.

An example in which, in the operational flow illustrated in FIG. 9, a representative word is extracted from each of contents, and content information items 600 are generated and associated with person information items 500 is described above. The embodiment, however, is not limited to this. For example, in another embodiment, the controller 101 may associate the content information items 400 with the person information items 500, extract a representative word from each of the contents, and generate a person management information item 800.

In the aforementioned example, in S911, the controller 101 extracts the representative word in accordance with the extraction rule based on the type. The embodiment, however, is not limited to this. For example, in another embodiment, in S911, the controller 101 may extract a predetermined number of representative words and limits, in accordance with the extraction rule information 700, the number of representative words for each of contents to be searched in the process of S1202.

The embodiment describes the example in which the contents are technical documents. The embodiment, however, is not limited to this. The contents may include a document other than technical documents. In the aforementioned embodiment, if equivalent terms (synonyms) are registered in the technical term dictionary 200, the synonyms may be processed in the same manner as the keywords in the processes executed using keywords included in entries of the technical term dictionary 200. The aforementioned processes may be shared and executed by multiple devices in a client and server system or the like.

Although the embodiment describes the example in which the processes of S913 to S917 illustrated in FIG. 9 are repeatedly executed on each of content information items 600, the embodiment is not limited to this. For example, in another embodiment, the processes of S913 to S917 illustrated in FIG. 9 may be repeatedly executed on each of person information items 500, and content information items 600 that correspond to the person information items 500 may be organized.

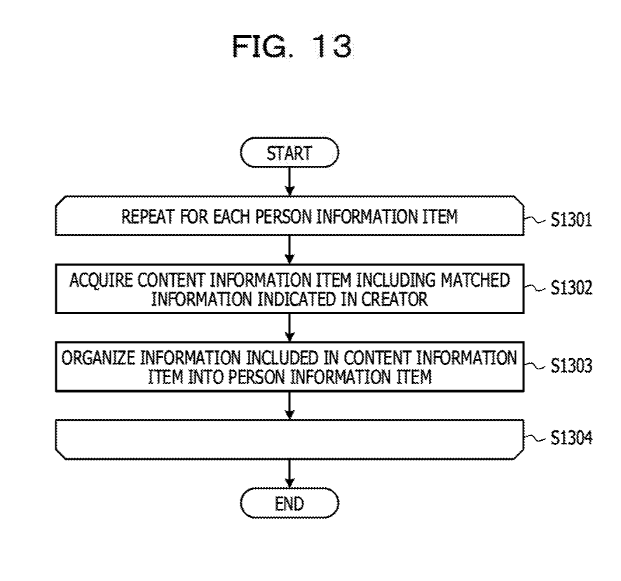

FIG. 13 is a diagram exemplifying a process to be repeatedly executed on each of person information items 500 to organize content information items 600 associated with the person information items 500 in another embodiment. The process illustrated in FIG. 13 may be executed instead of the processes of S913 to S917 illustrated in FIG. 9.

Processes of S1301 to S1305 are repetitive processes to be executed on each of the person information items 500. In S1301, the controller 101 reads a single person information item 500 from the storage 102 and acquires the person information item 500. In S1302, the controller 101 references information of creators indicated in content information items 600 and acquires a content information item 600 that includes information indicated in a creator of the content information item 600 and matching the acquired person information item 500.

In S1303, the controller 101 organizes, into the person information item 500, identification information indicated in the content information item 600 including the matched information of the creator, a detail indicated in the content information item 600, representative words indicated in the content information item 600, and characteristic values of the representative words. If the person information item 500 matches multiple content information items 600, the controller 101 may organize information included in the matched multiple content information items 600 into the person information item 500. By executing this process, the controller 101 may generate a person management information item 800. After the process is executed on all the person information items 500 and person management information items 800 are generated, the operational flow may be terminated.

As exemplified in FIG. 13, in another embodiment, the process may be repeatedly executed on each of the person information items 500, and the content information items 600 associated with the person information items 500 may be organized. In the aforementioned embodiment, in the processes of S915, S1301, and S1302, the controller 101 operates as the acquisition unit 111, for example. In the process of S911, the controller 101 operates as the extractor 113, for example. In the processes of S916 and S1303, the controller 101 operates as the generator 114, for example.

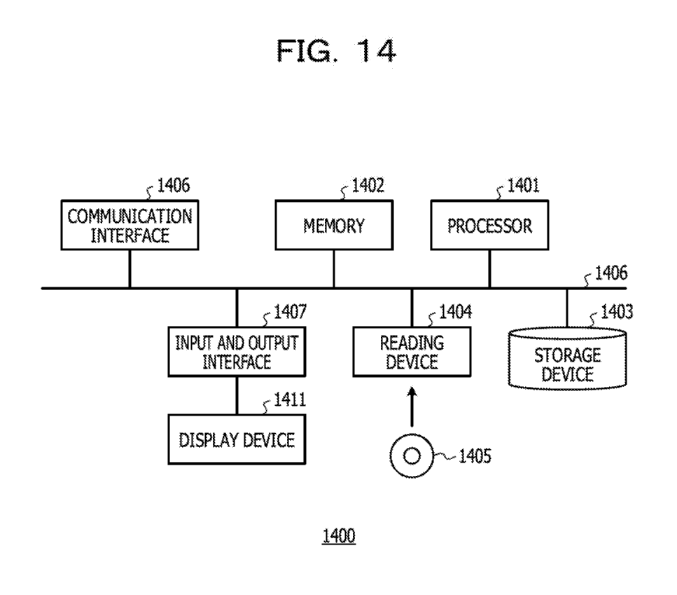

FIG. 14 is a diagram exemplifying a hardware configuration of a computer 1400 that achieves the information processing device 100 according to the embodiment. The computer 1400 illustrated in FIG. 14 and having the hardware configuration that achieves the information processing device 100 includes a processor 1401, a memory 1402, a storage device 1403, a reading device 1404, a communication interface 1406, an input and output interface 1407, and a display device 1411, for example. The processor 1401, the memory 1402, the storage device 1403, the reading device 1404, the communication interface 1406, and the input and output interface 1407 are coupled to each other via a bus 1408.

The processor 1401 may be a single processor, a multiprocessor, or a multi-core processor, for example. The processor 1401 uses the memory 1402 to execute an information generation program in which procedures for the aforementioned operational flows are described, thereby providing a part or all of the functions of the aforementioned sections. The processor 1401 of the information processing device 100 reads and executes the program stored in the storage device 1403, thereby operating as the acquisition unit 111, the extractor 113, and the generator 114.

The memory 1402 is, for example, a semiconductor memory and may include a RAM region and a ROM region. RAM is an abbreviation of Random Access Memory. ROM is an abbreviation of Read Only Memory. The storage device 1403 is, for example, a hard disk, a semiconductor memory such as a flash memory, or an external storage device. In the storage device 1403 of the information processing device 100, the technical term dictionary 200, the content information items 400 and 600, the person information items 500, the extraction rule information 700, the person management information items 800, and the association information 1000 are stored, for example.

The reading device 1404 accesses a detachable storage medium 1405 in accordance with an instruction of the processor 1401. The detachable storage medium 1405 is achieved by, for example, a semiconductor memory (USB memory or the like), a medium (magnetic disk or the like) to and from which information is input and output by a magnetic effect, a medium (CD-ROM, DVD, or the like) to and from which information is input and output by an optical effect, or the like. USB is an abbreviation of Universal Serial Bus. CD is an abbreviation of Compact Disc. DVD is an abbreviation of Digital Versatile Disc. The aforementioned storage 102 may include the memory 1402, the storage device 1403, and the detachable storage medium 1405, for example.

The communication interface 1406 transmits and receives data via a network in accordance with an instruction of the processor 1401. The input and output interface 1407 may be an interface between an input device and an output device, for example. The input device is a keyboard, a mouse, or the like that receives an instruction from the user, for example. The output device is a display device such as a display and an audio device such as a speaker, for example. In the example illustrated in FIG. 14, the input and output interface 1407 is coupled to a display device 1411. The display device 1411 is an example of the aforementioned display 103, for example.

The program according to the embodiment is provided to the information processing device 100 in the following manners.

(1) The program is installed in the storage device 1403 in advance.

(2) The program is provided from the detachable storage medium 1405.

(3) The program is provided by a server such as a program server.

The hardware configuration of the computer 1400 that is described with reference to FIG. 14 and achieves the information processing device 100 is an example, and the embodiment is not limited to this. For example, a part or all of the functions of the sections may be implemented as hardware such as an FPGA and SoC. FPGA is an abbreviation of Field Programmable Gate Array. SoC is an abbreviation of System-on-Chip.

The embodiments are described above. The embodiments are not limited to the aforementioned embodiments. It may be understood that the embodiments include various modified embodiments and alternative embodiments. For example, it may be understood that, in the embodiments, the constituent elements may be modified and achieved without departing from the gist and scope of the embodiments. In addition, it may be understood that various embodiments are achieved by combining multiple constituent elements disclosed in the aforementioned embodiments. Furthermore, it may be understood by persons skilled in the art that various embodiments are achieved by removing one or more constituent elements among all the constituent elements described in the embodiments, replacing one or more constituent elements among all the constituent elements described in the embodiments with one or more other constituent elements, or adding one or more constituent elements to the constituent elements disclosed in the aforementioned embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable storage medium storing a program that causes a computer to execute a process, the process comprising:
acquiring information identifying a person;
obtaining document data created by the person identified by the acquired information from a storage device based on the acquired information, the storage device storing pieces of document data;
extracting one or a plurality of words from the obtained document data in accordance with an extraction rule determined based on a type of the obtained document data;
generating person management information including the one or a plurality of words and the acquired information identifying the person; and
storing the person management information to the storage device.

2. The non-transitory computer-readable storage medium according to claim 1, wherein
the process further comprises:
receiving a search request including a search keyword; and
obtaining person management information including the search keyword from the storage device; and
outputting information indicating a person identified based on the obtained person management information.

3. The non-transitory computer-readable storage medium according to claim 1, wherein
the extracting includes:
calculating, for the one or a plurality of words, one or a plurality of characteristic values indicating characteristic degrees in the obtained document data, the one or a plurality of characteristic values corresponding to the one or a plurality of words respectively; and
extracting a predetermined number of words from the one or a plurality of words in descending order in the one or a plurality of characteristic values, the predetermined number being determined based on the type of the obtained document data.

4. The non-transitory computer-readable storage medium according to claim 3, wherein
the process further comprises:
excluding a sentence including a negative word or a part of the sentence from the obtained document data before the calculating.

5. The non-transitory computer-readable storage medium according to claim 1, wherein
when the obtained document data includes a question statement and an answer statement corresponding to the question statement, the extracting includes:
extracting one or a plurality of words from the question statement in accordance with a first extraction rule; and
extracting one or a plurality of words from the answer statement in accordance with a second extraction rule that causes a larger number of words to be extracted than the number of words to be extracted in accordance with the first extraction rule.

6. An information processing device comprising:
a memory; and
a processor coupled to the memory and the processor configured to execute a process, the process including:
acquiring information identifying a person;
obtaining document data created by the person identified by the acquired information from a storage device based on the acquired information, the storage device storing pieces of document data;
extracting one or a plurality of words from the obtained document data in accordance with an extraction rule determined based on a type of the obtained document data;
generating person management information including the one or a plurality of words and the acquired information identifying the person; and
storing the person management information to the storage device.

7. An information processing method executed by a computer, the information processing method comprising:
acquiring information identifying a person;
obtaining document data created by the person identified by the acquired information from a storage device based on the acquired information, the storage device storing pieces of document data;
extracting one or a plurality of words from the obtained document data in accordance with an extraction rule determined based on a type of the obtained document data;
generating person management information including the one or a plurality of words and the acquired information identifying the person; and
storing the person management information to the storage device.
